(19) United States
(12) Patent Application Publication
(10) Pub. No.: US 2013/0214936 A1
(43) Pub. Date: Aug. 22, 2013

(54) DEVICE FOR LEAK DETECTION IN A BRANCHED PIPE SYSTEM OF A WATER NETWORK

(71) Applicant: Seba Dynatronic Mess-und Ortungstechnik GmbH, (US)

(72) Inventor: Harald Schuberth, Breitenguessbach (DE)

(73) Assignee: SEBA DYNATRONIC MESS- UND ORTUNGSTECHNIK GMBH, Baunach (DE)

(21) Appl. No.: 13/738,321

(22) Filed: Jan. 10, 2013

(30) Foreign Application Priority Data
Feb. 22, 2012 (DE) 10 2012 003 459.8

(51) Int. Cl. G08B 5/22

(52) U.S. Cl. CPC G08B 5/22
USPC 340/870.03

(57) ABSTRACT

An apparatus for locating leaks in a branching pipeline (1) of a water supply network having numerous leak locating devices (9-11), which enable a locating of leaks at different locations in the water lines (2, 3), e.g. via an acoustic detection of the flow sounds and/or the pressure and/or the flow rate, wherein the locating of leaks occurs via at least one sensor (12) having a measurement component (13) and an evaluation component (14) connected thereto, and a communication link (17) is available for transmitting the detected signal and/or data to the display (21) of a user terminal (20), wherein the communication link (17) is designed as a WLAN connection between the leak locating device (9-11) and the user terminal (20), and an internet browser is allocated to the user terminal (20).

The invention concerns an apparatus for locating leaks in a branching pipeline of a water supply network having numerous leak locating devices, which enable the location of leaks at numerous locations in the water lines via sensors disposed therein.

The locating of leaks occurs, for example, via an acoustic detection of the sounds of the flow and/or the pressure and/or the flow rate, wherein the locating of the leaks occurs via at least one sensor having a measurement component and an evaluation component, and a communication link is available to transmit the detected signals and/or data to the display of a user terminal.

In order to control the measurement device or to display the results of the measurement, until now, special devices having their own software and a customized display have been used for locating leaks. Alternatively, PC based systems having a direct interface to the measurement electronics of the leak locating device have been used.

All of these known leak locating devices have the disadvantage that the software programs for the user interface have only been developed for a specific operating system and do not run on other terminals. If, for example, software is written for a PC running on “Windows 7” as the operating system, then this software will not run with other operating systems such as, e.g. “Android” or “MC OS” or “iOS,” “Linux” etc.

The invention therefore assumes the objective of developing an apparatus for locating leaks of the type specified above, with which it is possible to transmit the data and to visually display the data on a terminal, independently of the operating system.

To attain the objective, the invention is characterized by the technical teachings of Claim 1.

A substantial characteristic of the invention is that measurement and control electronics are disposed in the leak locating device, designed as a server for a WLAN connection, and that furthermore the receiver of the WLAN connection is disposed in the user terminal, and combined with a web browser connected to the internet.

For this, a port to a user interface is provided via the WLAN/WiFi interface disposed in the user terminal, and the data are processed such that they can be visually displayed on an internet browser disposed in the terminal and at the same time, various control functions can also be executed from there.

The user interface (control and display of data and processes) is imaged on the user terminal BE. This terminal can, e.g. be a smartphone, TouchPad, PC or the like. It must only contain, as well, a WLAN/WiFi module and an internet browser.

For this, the BE is independent of the operating system used (currently using, for example, MS Windows, Mac OS, iOS, Linux, Android).

What is novel with the system is that the communication between a user terminal with a display (e.g. PC, Notebook, Smartphone, Touchpad) and the measurement electronics runs via WLAN/WiFi and a web server implemented in the measurement electronics. By this means, the system is entirely independent of the operating system in the terminal used.

The focus of the present invention is therefore the processing and displaying of the data from the leak locating device in the user terminal, independently of the operating system (Windows, Linux, Mac OS, iOS, Android). The transmission units of the leak locating device make their data available via an integrated web server such that, in the user terminal, a simple browser is entirely sufficient. This concerns, fundamentally, however, a direct connection between transmission units and the user terminal, and public networks (internet etc.) are not used for this.

The terms WLAN and WiFi are used here synonymously.

Wi-Fi indicates both a company consortium, certifying devices with wireless interfaces, as well as the associated trademark term.

Because the term WiFi is used synonymously with the term WLAN in the framework of the present invention, in order to simplify the description, only the term WLAN shall be used henceforth.

A WLAN network concerns a local wireless network, which usually functions according to the standard IEEE-802.11 classification.

In contrast to a Wireless Personal Area Network (WPAN), WLANs have a greater transmitting power and range, and generally provide higher transmission speeds.

WLANs represent adaptations of the layers 1 and 2 of the OSI reference model, whereas in WPANs a network connection is created e.g. via an emulation of the serial ports and PPP or SLIB, respectively, provided in the network protocol. With WLAN the modulation procedure OFDM is normally used.

In a preferred design of the present invention, the WLAN network according to the invention functions in the ad-hoc mode. In this mode, no station has priority, but instead, all have the same value.

The prerequisites for the ad-hoc mode are the same as those for the infrastructure mode: all stations use the same network names (“Service Set Identifier,” SSID) and optionally, the same settings for encryption. Because there is no central authority (access point) in an ad-hoc network, the coordinating function thereof must be carried out by the terminals. A transference of data packets between the stations is not intended, and in practice, is not readily possible, because in the ad-hoc mode no data is exchanged which could provide the individual stations with an overview of the network. For these reasons, the ad-hoc mode is suitable only for a very limited number of stations (leak locating devices), which must be in close physical proximity to one another due to the limited range of the transmitter. If this is not the case, it may occur that one station is unable to communicate with all of the other stations, as this station simply no longer receives a signal.

In order to resolve this problem, the participating stations can be equipped with routing capabilities, such that they are capable of transmitting data between devices which are not within the transmission range of one another. Obtaining and exchanging of routing data is a part of the upgrading of an ad-hoc network to a mobile ad-hoc network: software components at each station collect data (e.g. for “visibility” of other stations, connection quality etc.), exchange said data among themselves and make decisions regarding the transmission of usage data.

According to a preferred design of the present invention, the WLAN network according to the invention works according to the standard IEEE 802.11a/h or the standard IEEE 802.11b/g/n. The use of newer standards, which have not been used previously, is within the scope of protection of the invention. For this reason, the previously given standards are only to be understood as examples.

The subject matter of the invention for the present invention is to be derived not only from the subject matter of the individual Claims, but also from the combinations of the individual Claims among themselves.

All of the information and characteristics disclosed in the documents, including the abstract, in particular the spatial design depicted in the drawings, are claimed as substantial to the invention, insofar as they are novel, individually or in combination, with respect to the prior art.

In the following, the invention shall be explained in greater detail based on drawings depicting only one possible design. Other characteristics and advantages of the invention, substantial to the invention, can be derived from the drawings and their descriptions.

They show:

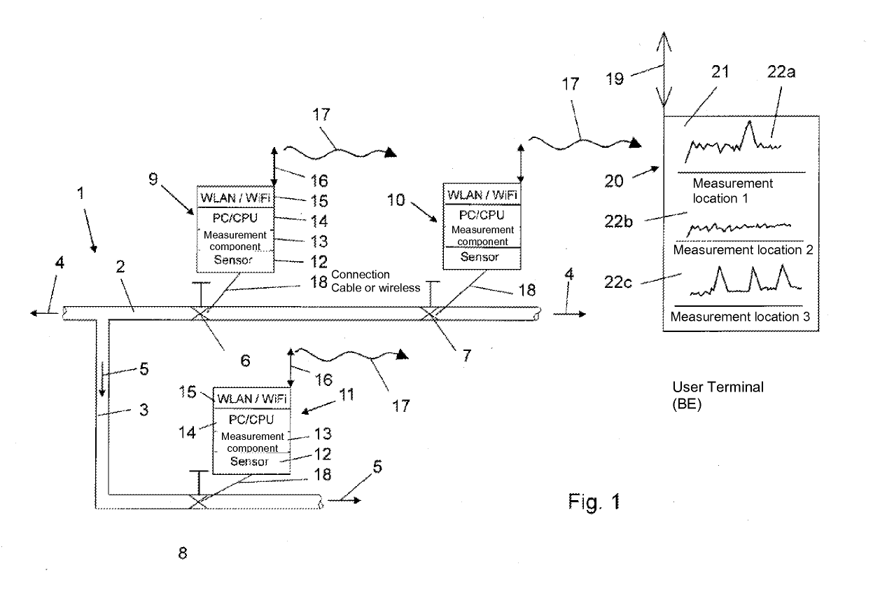

FIG. 1: a schematic block diagram of a data transference between the leak locating devices and a user terminal

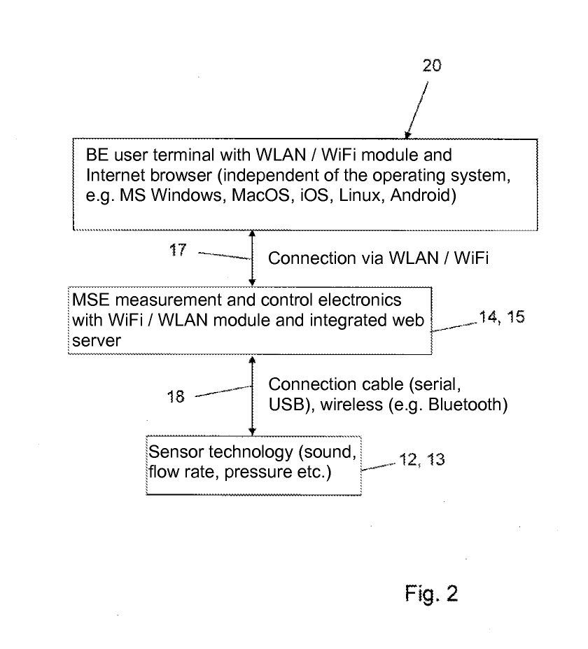

FIG. 2: a block diagram of a data transference between a leak locating device and a user terminal.

A number of branching water lines 2, 3 are disposed in a highly branching pipeline 1, wherein, in the embodiment example shown, the water flow flows in the direction of the arrows 4, 5.

A number of leak locating devices 9, 10, 11 are disposed at different locations on the distributed pipeline, wherein it is specified in the embodiment example that the leak locating devices 9-11 are each connected to a shut-off valve 6-8.

The invention is not limited to this. The leak locating devices 9-11 can also be disposed at other locations in the pipeline 1. Each leak locating device 9-11 has an acoustic sensor 12, suited for listening to the sound of the flow at the shut-off valves 6, 7, 8.

Instead of an acoustic sensor, other sensors may also be used, such as, e.g. ultrasound sensors and other locating sensors, which are suited for detecting the sound of the flow, the rate of the flow, or other parameters necessary for locating leaks.

The signal from the sensor 12 is sent to the leak locating device 9-11 via a data link 18.

Said data link 18 can be designed as a cable or a wireless data link.

A wireless data link of this type can be an IR interface, a Bluetooth interface or another near field communication (NFC).

The signal from the sensor 12 is processed in a measurement component 13 and the complete control of the leak locating device 9-11 is processed in a control module 14, which can be designed as a PC or CPU.

It is also important that the sensor 12, with the measurement component 13 and the control module 14, can be designed as an ASIC, and all of the specified modules can be located on a single circuit board.

The data processed by the control module 14 are then sent to the transmission level 15, which is preferably designed as a WLAN client.

The wireless communication occurs via the antennas 16 and the communication link 17 to the user terminal 20.

This is designed to be independent of the operating system, and it is only depicted that a display screen 21 is disposed in the user terminal, and if applicable, other actuation buttons or a keyboard, with which it is possible to further process the images 22 of the various measurement points displayed on the display screen 21.

In the embodiment example shown, the communication links 17 between the respective leak locating devices 9-11 and the user terminal 20 are designed as unidirectional interfaces.

The invention is not limited to this.

In the case of a bidirectional communication link, the antenna at the user terminal 20 is equipped as a transmitting and receiving antenna, and can, accordingly, transmit signals to the individual leak locating devices 9-11, and have an effect on said.

It should be mentioned that it is possible in a further development of the invention to design the individual transmission levels 15 of the leak locating devices 9-11 such that they are routing capable, which means that if, for example, a leak locating device (e.g. the leak locating device 11) is outside of the range of the user terminal, said leak locating device 11 then sends its data to another leak locating device 9 or 10, and said leak locating device then forwards the data from the leak locating device 11 to the user terminal 20.

FIG. 2 shows a schematic block diagram of the configuration according to the invention, with which it is important that the user terminal is equipped with a WLAN-WiFi module and an internet browser, and for this reason, functions independently of the respective operating system.

### DRAWINGS LEGEND

1. pipeline
2. water line
3. water line
4. direction of arrow
5. direction of arrow
6. shut-off valve
7. shut-off valve
8. shut-off valve
9. leak locating device
10. leak locating device
11. leak locating device
12. sensor
13. measurement component
14. control module (PC or CPU)
15. transmission level (WLAN/WiFi)
16. antenna
17. communication link
18. data link
19. transmitting and receiving antenna
20. user terminal
21. display screen
22. image (a, b, c)

1. An apparatus for locating leaks in a branching pipeline (1) of a water supply network having numerous leak locating devices (9-11), which enable the locating of leaks at different locations in the water lines (2, 3), e.g. via an acoustic detection of the flow sounds and/or the pressure and/or the flow rate, wherein the locating of leaks occurs via a least one sensor (12) having a measurement component (13) and an evaluation component (14) connected thereto, and a communication link (17) for transmitting the received signal and/or data to the display (21) of a user terminal (20) is available, characterized in that the communication link (17) is designed as a WLAN connection between the leak locating device (9-11) and the user terminal (20), and an internet browser is allocated to the user terminal (20).

2. The apparatus according to claim 1, characterized in that a WLAN/WiFi module and an internet browser connected thereto are disposed in the user terminal (20).

3. The apparatus according to claim 1, characterized in that the internet browser in the user terminal (20) is independent of the operating system used.

4. The apparatus according to claim 1, characterized in that a WLAN module designed as a server is disposed as a transmission level (15) in the leak locating device (9-11).

5. The apparatus according to claim 1, characterized in that all leak locating devices (9-11) in the WLAN network communicate in the ad-hoc mode with the user terminal (20).

6. The apparatus according to claim 5, characterized in that the WLAN network is operated in the ad-hoc mode and all transmission levels (15) use the same network names (“Service Set Identifier,” SSID) and, optionally, use the same settings for encryption.

7. The apparatus according to claim 5, characterized in that the coordinating function of the WLAN network is executed by the one or more terminals (12).

8. The apparatus according to claim 1, characterized in that the leak locating devices (9-11) are equipped with routing capabilities, such that they are capable of transferring data between the individual leak locating devices (9-11), which are not within the transmission range of the user terminal (20).

9. The apparatus according to claim 1, characterized in that the user terminal (20) is designed as a PC or Notebook, or as a Smartphone or as a Touchpad.

10. The apparatus according to claim 1, characterized in that the WLAN network functions according to the IEEE 802.11 a/h standard and/or according to the IEEE 802.11b/g/n standard.

11. The apparatus according to claim 2, characterized in that the interne browser in the user terminal is independent of the operating system used.

12. The apparatus according to claim 2, characterized in that a WLAN module designed as a server is disposed as a transmission level in the leak locating device.

13. The apparatus according to claim 3, characterized in that a WLAN module designed as a server is disposed as a transmission level in the leak locating device.

14. The apparatus according to claim 2, characterized in that all leak locating devices in the WLAN network communicate in the ad-hoc mode with the user terminal.

15. The apparatus according to claim 3, characterized in that all leak locating devices in the WLAN network communicate in the ad-hoc mode with the user terminal.

16. The apparatus according to claim 4, characterized in that all leak locating devices in the WLAN network communicate in the ad-hoc mode with the user terminal.

17. The apparatus according to claim 6, characterized in that the coordinating function of the WLAN network is executed by the one or more terminals.

18. The apparatus according to claim 2, characterized in that the leak locating devices are equipped with routing capabilities, such that they are capable of transferring data between the individual leak locating devices, which are not within the transmission range of the user terminal.

19. The apparatus according to claim 3, characterized in that the leak locating devices are equipped with routing capabilities, such that they are capable of transferring data between the individual leak locating devices, which are not within the transmission range of the user terminal.

20. The apparatus according to claim 4, characterized in that the leak locating devices are equipped with routing capabilities, such that they are capable of transferring data between the individual leak locating devices, which are not within the transmission range of the user terminal.
